(19) United States
(12) Patent Application Publication
(10) Pub. No.: US 2007/0283022 A1
(43) Pub. Date: Dec. 6, 2007

(54) Allocation of a call state control function to a subscriber

(75) Inventors: Zsolt Rajko, Lovasbereny (HU); Gabor Jaro, Budapest (HU); Andras Szeman, Budapest (HU); Jozsef Varga, Nagydobsza (HU)

Correspondence Address: FOLEY & LARDNER LLP, P.O. BOX 80278, SAN DIEGO, CA, 92138-0278, US

(73) Assignee: Nokia Corporation

(21) Appl. No.: 11/486,844

(22) Filed: Jul. 14, 2006

(30) Foreign Application Priority Data
May 30, 2006 (GB) GB 0610635.5

(51) Int. Cl. G06F 15/16

(52) U.S. Cl. 709/227; 709/230

(57) ABSTRACT

A method of allocating one of a plurality of call state control functions to a subscriber, the method comprising: sending registration requests to the plurality of call state control functions; storing information regarding the availability of the call state control functions in response to unsuccessful registration requests; and determining a call state control function for the subscriber in dependence on said stored information.

### CROSS-REFERENCE TO RELATED PATENT APPLICATIONS

Great Britain Priority Application GB 0610635.5, filed May 30, 2006 including the specification, drawings, claims and abstract, is incorporated herein by reference in its entirety.

### FIELD OF THE INVENTION

The present invention relates to the registration of a subscriber in a wireless network. The invention is applicable to the registration of a subscriber in a home network, whether the subscriber is roaming or not. The invention particularly relates to a technique for allocating a call state control function for such a subscriber based on the availability and/or unavailability of the call state control functions located in the network.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

IP Multimedia Subsystem (IMS) utilizes Session Initiation Protocol (SIP) for initiating and controlling service requests. A proxy call state control function (P-CSCF) is the first point of contact for an IMS user equipment and is assigned to the user terminal during registration. User profile information for the IMS user equipment is provided by a home subscriber server (HSS). In current telecommunication networks resiliency is an important requirement, i.e., the network should be able to provide services even if certain network elements are faulty or down.

As part of the registration of a mobile terminal in a home network, it is necessary for some resources to allocate a serving call state control function (S-CSCF). The S-CSCF is responsible for call routing, and provides a service control interface for a user towards application servers. A S-CSCF may be associated with a plurality of mobile terminals, and consequently may support the routing for a plurality of calls. A S-CSCF may support various types of calls or sessions, such as voice over IP calls and multimedia sessions, e.g., for gaming.

The resource that allocates the serving call state control function (S-CSCF) for a mobile terminal is an interrogating call state control function (I-CSCF), which includes the functionality of a S-CSCF allocation. For a mobile terminal in a home network, such an I-CSCF in the home network selects the S-CSCF for the mobile terminal.

“3^{rd} Generation Partnership Project Technical Specification 24.229” (3GPP TS 24.229), Release 7 standard (v.7.2-0, 2005-12), section 5.3.1.2 and 5.3.1.3 (pages 56-57) specifies a registration procedure for an I-CSCF. The procedure includes selection of a S-CSCF. In typical IMS networks there are several S-CSCF elements that are able to serve registrations. If a selected S-CSCF is not able to serve the registration request then it is the I-CSCF's responsibility to select another S-CSCF from the network.

According to the Release 7 standard, if a selected S-CSCF does not respond to a registration request or reply with an error code, the I-CSCF selects a new S-CSCF. However, it is possible that the new S-CSCF will actually be the S-CSCF that has already been tried and which could not serve the request. The standard doesn't specify how to find a new S-CSCF. The I-CSCF may also select the same faulty S-CSCF for other registration attempts.

Additionally, it may happen that the I-CSCF does not receive any transport level error from the S-CSCF (nor any SIP response) in which case the I-CSCF will only realize that the S-CSCF is not available when the SIP transaction timer expires. However, in this case it is too late to select another S-CSCF because the same transaction timer also expires in the P-CSCF. Thus registration will fail.

Furthermore, if the S-CSCF address is assigned to the subscription in the HSS, then the same S-CSCF is selected first in the case of any further registration attempt and the registration attempt may continue to fail due to timeout as described above. As a consequence, the user equipment will not be able to register to the network and thus services provided by network won't be available for the subscriber.

The patent application WO 03/075596 seeks to address some of the aforementioned problems. WO 03/075596 describes an arrangement in which the S-CSCF provides the I-CSCF with details as to its current load status. This information is provided on successful completion of the registration process. The load information is then used by the I-CSCF when determining the allocation of a S-CSCF for the registration of future subscribers. In this way, the I-CSCF can use the current load of each S-CSCF to spread the loading such that S-CSCFs with low loading are utilised. In the preferred messaging, once an SIP session is established with an S-CSCF, the S-CSCF provides its supporting I-CSCF with an indication as to whether or not it is able to initiate new registrations. This is done by issuing a control signal to the I-CSCF. The S-CSCF may transmit a RE-INVITE message to the I-CSCF, re-inviting the I-CSCF to establish new registrations therewith. This can be considered to be a ‘keep-alive’ mechanism. The RE-INVITE message is transmitted periodically in accordance with SIP specifications. If the S-CSCF is operating with no spare load capacity, and is therefore unable to accept new registrations, the S-CSCF transmits a SUSPEND message to the I-CSCF, indicating that no further new registrations can be established with the S-CSCF. At some time thereafter the load on the S-CSCF may be reduced sufficiently to enable the S-CSCF to receive new registrations. As such, the S-CSCF can transmit a RESUME message to the I-CSCF.

The aforementioned arrangement requires that all the S-CSCFs are arranged to monitor their loading capacity and periodically send signals to the I-CSCF regarding their status. This results in a signalling burden on the network. Furthermore, the arrangement does not account for the situation where an S-CSCF may be unavailable due to some other reason, such as a fault, rather than just because it has reached its loading capacity. In such a scenario, the I-CSCF may try to select a S-CSCF which is unavailable. Furthermore, if a selected S-CSCF does not respond to a registration request or reply with an error code, the I-CSCF may proceed to re-select the same S-CSCF, and the registration may thus fail.

The present invention aims to solve the aforementioned problems

### SUMMARY OF THE INVENTION

According to a first aspect of the present invention there is provided a method of allocating one of a plurality of call state control functions to a subscriber, the method comprising: sending registration requests to the plurality of call state control functions; storing information regarding the availability of the call state control functions in response to unsuccessful registration requests; and determining a call state control function for the subscriber in dependence on said stored information.

By saving information in response to unsuccessful registration requests, and selecting call state control functions based on this information, the present invention can avoid re-selecting the same call state control function again during retry attempts if the call state control function is unavailable, for example, due to a network element being faulty or down. Furthermore, the invention does not require, as an essential feature, that the call state control functions periodically send signals regarding their availability. Thus, the signalling burden on the network and the complexity of the call state control functions can be reduced.

Preferably, the registration requests are sent from a network element and the same network element stores the information. The network element may then determine a call state control function for a subscriber in dependence on the stored information. In fact, the network element may contain all the necessary hardware/software in order to implement the invention such that the invention can easily be incorporated into an existing network.

The call state control functions may be S-CSCFs and the network element may be an I-CSCF. Alternatively, the call state control functions may be I-CSCFs and the network element may be a P-CSCF. As such, it can be seen that the invention can be implemented in a network in various different ways. In one embodiment, the functionality of the present invention may be provided in more than one type of network element. For example, the method may be implemented in a P-CSCF for selection of an I-CSCF, and also in the I-CSCF for selection of a S-CSCF. The P-CSCF may be located in a home network or in a visited network.

The determining step preferably comprises selecting a call state control function for the subscriber and accessing the stored information to determine whether the selected call state control function is indicated as being unavailable. If the selected call state control function is indicated as being unavailable then another call state control function may be selected. Otherwise, a registration request may be sent to the selected call state control function. If the registration request is unsuccessful, then the stored information regarding the selected call state control function is changed to reflect its status, a different call state control function is selected, and the aforementioned procedure is repeated.

Preferably, the stored information comprises a plurality of availability indicators, each availability indicator associated with a call state control function. The value of the availability indicator reflects the availability or otherwise of its associated call state control function. In response to unsuccessful registration requests, the availability indicator may be changed to indicate that the associated call state control function is unavailable. When a call state control function is unavailable it may be identified as such on a so-called black list. An algorithm is advantageously employed to determine which of the call state control functions should be entered on the black list.

The state of the availability indicator may be changed after a predetermined time period in order to prevent a call state control function form being permanently black listed. For example, the value of the availability indicator may be periodically reduced. This allows for the status of a call state control function to change over time. In one arrangement, the availability of a call state control function is monitored to determine when it becomes available, and the call state control function is taken off the black list when it is determined that the call state control function is available.

The availability of call state control functions may be determined by error messages received from the call state control functions in response to registration requests. These error messages may be categorized and the availability indicator may be changed according to the category of error message.

Advantageously, a weight factor is assigned to each category of error message, and the availability indicator is changed in accordance with the weight factor. This functionality allows different errors to have different effects on the availability indicator according to the severity of the error.

In a particularly preferred arrangement, the number of error messages that have been received from a call state control function is taken into account in determining whether the call state control function is unavailable. The availability indicator may be dependent on the weight factor and/or the number of error messages received. A call state control function may be indicated as being unavailable if the value of the availability indicator is above a threshold value. An upper limit may be set for the value of the availability indicator so as to prevent it becoming too high. A monitoring request may be sent to a call state control function when the value of its associated availability indicator falls below the threshold value to determine whether the call state control function is available.

According to another aspect of the present invention there is provided a network element adapted to perform the method described herein.

According to another aspect of the present invention there is provided a telecommunications network comprising the network element and a plurality of call state control functions.

According to another aspect of the present invention there is provided a computer program product, embodied on a computer readable medium, being adapted to perform any of steps of method described herein when the program is run on a computer or on a processor.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

For a better understanding of the present invention and to show how the same may be carried into effect, embodiments of the present invention will now be described by way of example only with reference to the accompanying drawings, in which:

FIG. 1 shows a basic topology of a home network and a visited network;

FIG. 2 shows the stages of registration of a subscriber in the visited network of FIG. 1; and

FIG. 3 illustrates a S-CSCF selection algorithm according to an embodiment of the present invention

### DETAILED DESCRIPTION OF THE PREFERRED EMBODIMENTS

It will be understood that in the following description, the present invention is described with reference to particular non-limiting examples from which the invention can be best understood. The invention, however, is not limited to such examples.

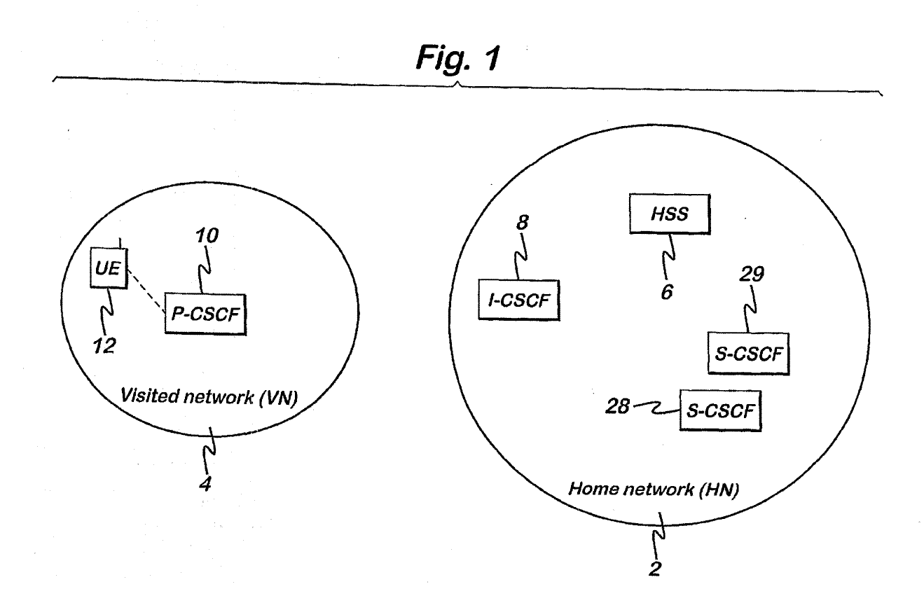

With reference to FIG. 1, there is described the network elements for initial registration of a subscriber located in a visited network.

Referring to FIG. 1, there is illustrated a home network (HN) 2 and a visited network (VN) 4. The home network 2 includes a home subscriber server (HSS) 6 and an interrogating call state control function (I-CSCF) 8. The home network also includes serving call state control functions (S-CSCFs), two of which are represented in FIG. 1 by reference numerals 28 and 29. The visited network 4 includes a proxy call state control function (P-CSCF) 10 and a user equipment (UE) 12 associated with a subscriber.

In the example of FIG. 1, the UE 12 is associated with the home network 2 and is normally connected in the home network 2. The UE is a roaming UE and has consequently roamed into the visited network 4. In accordance with known techniques, it is therefore necessary for the UE 12 to register with the home network 4.

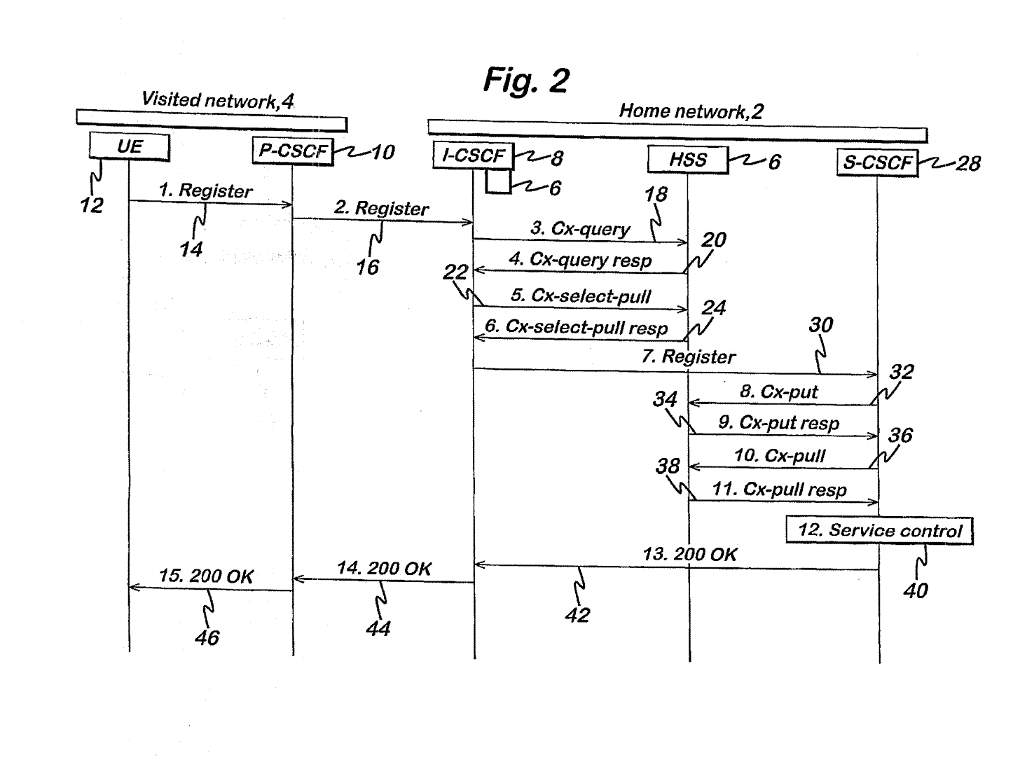

Referring to FIG. 2, there is illustrated the implementation of a technique for the initial registration of the UE 12 located in the visited network 4. It is assumed that radio bearers are already established for signalling, and a mechanism exists for the first message of the registration procedure to be forwarded from the UE 12 to the P-CSCF 10 in accordance with known techniques.

After the UE 12 has obtained its signalling channel through the access network (i.e. the visited network), registration can be performed. To initiate registration, the UE 12 sends a register signal, as identified by arrow 14, to the P-CSCF 10 in the visited network. The register information flow sent by the UE 12 includes its subscriber identity and the domain name of its home network 2.

Upon receipt of the register information flow, the P-CSCF 10 examines the home domain name to identify the entry point into the home network 2. The entry point into the home network 2 is through the I-CSCF 8. The P-CSCF 10 then sends the register information flow to the I-CSCF 8 of the home network as indicated by the arrow 16.

The register information flow sent from the P-CSCF 10 includes the P-CSCF 10 “name” in a contact header, the subscriber identity (i.e. the mobile terminal's identity), and the subscriber contact name. A name-address resolution mechanism is utilised by the P-CSCF 10 in order to determine the address of the home network from the home domain name provided by the mobile terminal 12.

When the I-CSCF 8 receives the registration information flow from the P-CSCF 10, it examines the subscriber identity and the home domain name, and employs the services of a name-address resolution mechanism to determine the HSS 6 address to contact.

The I-CSCF 8 sends a query information flow, as represented by arrow 18, to the HSS 6. The query information flow includes the P-CSCF name, the user terminal's subscriber identity, and the home domain name. The P-CSCF name is the contact name that the operator of the home network uses for future contact to that P-CSCF.

The HSS 6 checks whether the user is already registered with the home network. In accordance with known techniques, the HSS 6 then determines whether the user is allowed to register in that visited network.

The HSS 6 sends a query response as indicated by arrow 20, to the I-CSCF 8. At this stage it is assumed that the authentication of the mobile terminal has been completed. The I-CSCF 8 sends a select-pull signal, as represented by arrow 22, to the HSS 6. The select-pull signal includes the subscriber identity, and requests information from the HSS 6 relating to the required serving call state control function capabilities for the mobile terminal. The required serving call state control function capabilities are used to select an appropriate call state control function at a later step in the registration cycle.

Responsive to the select-pull signal from the I-CSCF 8, the HSS 6 sends a select-pull response signal, as represented by arrow 24, to the I-CSCF 8. The select-pull response signal details the required serving call state control function capabilities. The HSS 6 provides information as to the required serving call state control functions in accordance with the mobile terminal's subscription information, held by the HSS 6 in the subscriber's home network.

The I-CSCF 8, including the S-CSCF allocation function as represented by block 26 in FIG. 2, determines the name of an appropriate S-CSCF in the home network 2. The I-CSCF 8 determines, in this example, the selection of S-CSCF 28. The I-CSCF 8, using the name of the S-CSCF 28, determines the address of the S-CSCF 28 through a name-address resolution mechanism, and then sends the register information flow to the selected S-CSCF 28 as represented by arrow 30. The register information flow includes the P-CSCF 10 “name” in the contact header, and the user terminal subscriber identity and contact name.

The S-CSCF 28 sends a put signal, as represented by arrow 32, to the HSS 6. The put signal includes the subscriber identity of S-CSCF 28. This effectively registers the S-CSCF 28 as the serving call state control function for the UE 12 in the home network, so that the HSS 6 can direct the call connections appropriately. The HSS 6 stores the S-CSCF 28 name for the subscriber.

The HSS 6 sends a put response signal as represented by arrow 34, to the S-CSCF 28 to acknowledge receipt of the put signal.

On receipt of the put response information flow from the HSS 6, the S-CSCF 28 sends a pull information arrow 36, including the subscriber identity, to the HSS 6 in order to download the subscriber profile to the HSS 6 to the S-CSCF 28. The S-CSCF 28 stores the P-CSCF name as supplied by the visited network. This represents the name to which the home network forwards the subsequent terminating session signalling for the UE 12.

The HSS 6 returns an information flow pull response signal, as represented by arrow 38, to the S-CSCF 28. The pull response signal includes the subscriber profile. The S-CSCF 28 then stores the subscriber profile for that indicated user. The S-CSCF 28 may perform whatever service control procedures are appropriate, as indicated by block 40. The S-CSCF 28 then returns a 200 OK information flow as represented by arrow 42, to the I-CSCF 8. The 200 OK information flow is well known in the art, and includes the serving network contact name (in this case the home network 2) and the S-CSCF 28 name.

As represented by arrow 44, the I-CSCF 8 then sends the information flow 200 OK to the P-CSCF 10. The I-CSCF 8 releases all registration information after sending the information flow 200 OK. The P-CSCF 10 stores the serving network contact name, and sends the information flow 200 OK to the mobile terminal as represented by arrow 46. The registration process is then complete. The completion of the registration process, including the format of the 200 OK signals transmitted to complete such, is well known in the art.

Embodiments of the present invention which can be implemented in the previously described system are now described in more detail.

Embodiments of the present invention provide a mechanism that can be used by the I-CSCF to keep track of unreachable S-CSCF servers and avoid the above-described problems by selecting only an S-CSCF that is known to be available. In addition, an algorithm is proposed, based on the error messages received from the S-CSCFs, to diagnose whether the problem of a failure S-CSCF is long-lasting or temporary. If the failure of a S-CSCF is considered to be long-lasting, it will have low priority to be re-tried later.

When the I-CSCF selects an S-CSCF (either based on capabilities or because it has received the server name from the HSS), which fails to server the registration attempt then the I-CSCF should consider putting an indicator of the S-CSCF on a so-called black list. An algorithm, as described below, may be utilized to decide whether or not the S-CSCF should be put on the black list. An input parameter for the algorithm may be the type of error that occurred during processing of the registration request (e.g. the request could not be sent to the S-CSCF due to a transport error, or the S-CSCF did not answer at all). The algorithm may be stateful, i.e. it may store earlier events related to same S-CSCF and utilize these to determine whether the S-CSCF should be on the black list.

The S-CSCF selection procedure is modified such that when the I-CSCF has selected an S-CSCF it checks whether the S-CSCF is enrolled on the black list. If it is, then either another S-CSCF is selected if possible, and if not, then the registration attempt may be rejected or the S-CSCF may be tried again (even though that is on the black list, there may be a chance that the S-CSCF has recovered since the last error).

Once the black list is introduced there may be another algorithm that defines when a given S-CSCF should be removed from the black list. The algorithm may be based on a monitoring of the listed servers or, for example, on more simple time criteria (i.e. an S-CSCF server is removed from the black list after a given time). The algorithm described below is based on monitoring but considers also the time that has elapsed since a server was enrolled on the black list.

Advantages of embodiments of the present invention include avoiding the re-selection of a non-functional server and tracking of non-functional servers by using a black list and predicating the problem, whether long-lasting or temporary.

Example algorithms for implementing embodiments of the present invention are described below.

Algorithm 1

This algorithm takes into account how the registration attempt has failed. Possible failures are categorized and the category is input for the algorithm. The algorithm does not limit in any way the number of possible categories. Just as an example one possible categorization could be:

Category 1: sending of request has failed due to transport error.

Category 2: S-CSCF answered with 3xx/480/5xx response for the request.

Category 3: S-CSCF did not answer, SIP transaction expired.

Weight factors are assigned to the categories. The weight factors reflect how serious and long term the errors in that category are considered. If a weight factor is high, errors in the category are considered to be long lasting and not easily recoverable. Thus occurrence of any error in the category is a good reason to put the server on the black list. If a weight factor is low then errors in the category are probably not long-lasting ones, or may somehow relate to the particular request. Low weight indicates that many of there errors should occur in a given time period before a server is put on the black list. One such error in itself may not be a good enough reason.

The algorithm uses the following parameters:

Availability Indicator (AI)

This parameter is assigned for each server name. A zero value means that a server is considered available. If there is any error related to the server then this value is increased with the weight factor of the category in which the given error belongs. If the value of AI for a server crosses a threshold value then the server is black listed, i.e. it is considered not available.

It is not necessary to keep track of server names with a zero AI value. Those server names can be removed from the store and any server for which there is no AI maintained in the store is considered to have a zero AI value. The AI value cannot be decreased below zero.

Threshold (TH)

This parameter defines a threshold value for AI. If the AI value of a given server is increased above TH, the server is black listed.

Availability Indicator Limit (AIL)

This parameter defines an upper limit for AI. The value of AI cannot be increased above this limit. If the value of AI would be increased above AIL, then the value of AI is kept instead at the AIL.

Black List Flag (BL)

This parameter is a flag that indicates whether a server is black listed or not.

Obsolescence Time (OT)

This parameter defines a timer period. AI values are decreased periodically in order that servers do not remain black listed forever. After the end of each timer period defined by OT, all AI values are decreased by a value known as the Obsolescence Value.

Obsolescence Value (OV)

This parameter defines the value that is subtracted from each AI value after each OT period.

The algorithm has the following input events:
CheckServer (ServerID): Algorithm should check whether a given server is black listed or not.
   If ServerID is not found on the list maintained by algorithm then return value is White.
   If ServerID is found on the list and
      BL is set to false then return value is White.
      BL is set to true and AI is above TH then return value is Black.
      BL is set to true and AI is below TH then return value is Gray.

A white return value means the server is available and should be used. A black return value means that the server is not available and another server should be selected. A gray return value means that the server is on the black list but it is time to check it's availability, thus a request should be forwarded to the server and the result should be reported with the “ReportServerStatus” method described below.
ReportError (ServerID, Category): An error related to ServerID is reported. AI of the ServerID is increased with the weight factor associated with the category of error. If AI is increased above TH, the BL flag is set to true (if it is not set yet).
ReportServerStatus(ServerID, Result): Server has been on the black list and a request has been forwarded to the server to check its status. Results indicate whether the request was served successfully or if not, the category of the error that occurred. If the result indicates success, the corresponding server is removed from the list maintained by the algorithm (i.e. it is removed from the black list and it will have an AI value of zero). If Result indicates an error category, the server's AI is set to TH+the weight factor of the category.

The algorithm can be further enhanced by introducing following parameter:

ObsolescenceFactor (OF)

OF defines how many times OT must elapse in order to decrease the AI (by the OV value) associated with a given server. OF is server specific. It is set to a default value 1 when a server first receives an AI value and it is reset to 1 whenever AI drops to zero. OF should be increased (e.g., multiplied by 2) every time a ReportServerStatus method is initiated for the server with a Result other than successful. This OF factor could ensure that if a server is not reachable for a longer time then it is not checked too frequently (as every checking has the cost of an unsuccessful end user request). Frequency of the status check decreases as OF is increased.

Algorithm 2

This algorithm is a variation of the one described above. Error categories are defined in the same way and a server is blacklisted according to the same criteria. The difference is that there is a separate monitoring activity implemented, instead of forwarding an end-user request to the server. This means that once the AI falls below TH for a blacklisted server, the algorithm should immediately send a monitoring request toward the server and update the status based on the outcome. This requires that the server understands and answers the monitoring request.

Embodiments of the invention improve resiliency of the network and provide a solution for the service denial scenario (when a user equipment is not able to register to network). Algorithms 1 and 2 use the same mechanism to put server names on the black list. Algorithm 1 forwards the next end-user request to the server when it is time to check its status. An advantage of this solution is that it is not necessary to have an additional supervision mechanism between the SIP servers. The drawback is that it may result in more unsuccessful end-user requests.

Algorithm 2 uses a separate supervision mechanism to check the status of other servers. This requires the existence of a mechanism that is supported by all of the servers. For an IMS network, this supervision could be done, e.g., by using the OPTIONS method. The advantage of this solution is that no end-user request is forwarded to a server while it is on the black list. Thus it results in less failed end-user requests.

Usage of a blacklist and algorithms according to embodiments of the present invention is not limited to the S-CSCF re-selection scenario. For example, it can also be applied in a P-CSCF for an I-CSCF selection procedure.

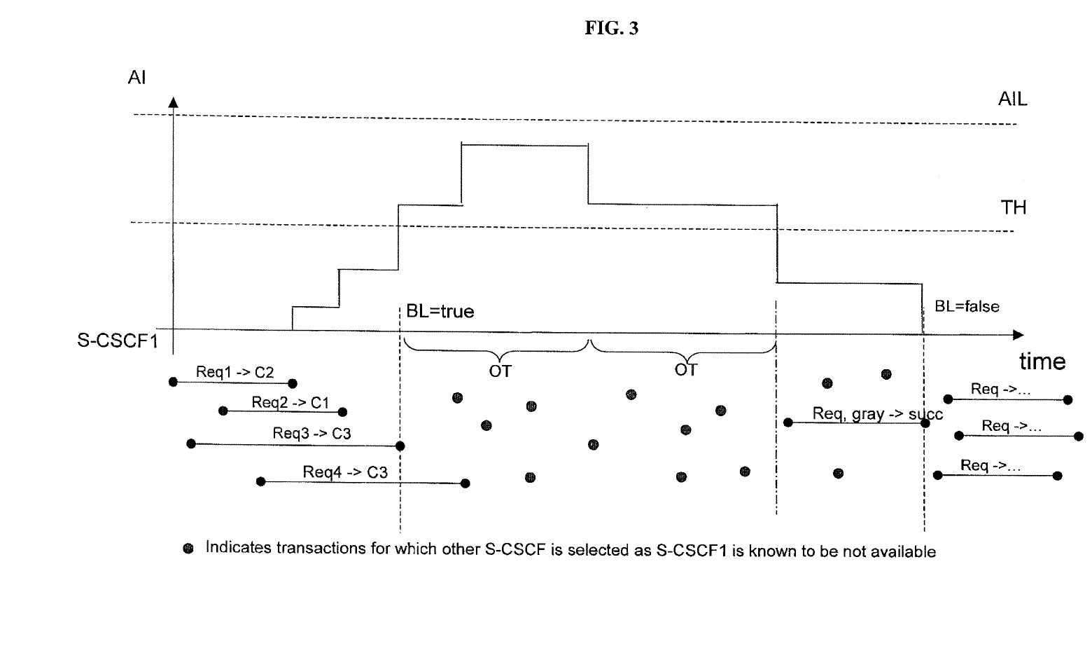

FIG. 3 illustrates an S-CSCF selection algorithm in use. FIG. 3 plots the availability indicator (AI) vs Time of S-CSCF1 as a number of registration requests, Req1, Req2, Req3, and Req4, are made. Various error events occur in response to the requests which are categorized C1, C2, and C3. C1 corresponds to a transport error having a weight W=4. C2 corresponds to the S-CSCF sending a response that triggers re-selection and has a weight W=2. C3 corresponds to the S-CSCF not answering the request and has a weight W=6.

The threshold (TH) for S-CSCF is set at 10, the Failure Indicator Limit (FIL) equals 20, the Obsolescence Time (OT) is 60 sec and the Obsolescence Value (OV) is 6.

After three requests (Req1, Req2, Req3) which return events in the categories C2, C1 and C3, respectively, the AI rises to 12 (W=2 for C2, W=4 for C1, and W=6 for C3, giving an AI of 2+4+6=12). As AI is above the TH value of 10, request Req3 pushes the S-CSCF1 onto the black list and another S-CSCF is selected during the retry. A fourth request, Req4 initiated before S-CSCF1 is put on the black list pushes the AI up to 18. For subsequent requests, other S-CSCFs are selected as S-CSCF1 is on the black list. After each 60 second period the AI is reduced by 6 as OT=60 seconds and OV=6. Thus after 2 minutes the AI falls by 12 to a value of 6. A subsequent grey category request is successful and the S-CSCF1 is removed from the black list.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of allocating one of a plurality of call state control functions to a subscriber, the method comprising:
sending registration requests to the plurality of call state control functions;
storing information regarding the availability of the call state control functions in response to unsuccessful registration requests; and
determining a call state control function for the subscriber in dependence on said stored information.

2. The method according to claim 1, wherein the sending, storing and determining steps are performed by a network element.

3. The method according to claim 2, wherein the network element is an interrogating call state control function and the call state control functions are serving call state control functions.

4. The method according to claim 2, wherein the network element is a proxy call state control function and the call state control functions are interrogating call state control functions.

5. The method according to claim 1, wherein the determining step comprises selecting a call state control function for the subscriber and accessing the stored information to determine whether the selected call state control function is available.

6. The method according to claim 5, wherein if the selected call state control function is determined as being unavailable then another call state control function is selected, whereas if the selected call state control function is determined to be available then a registration request is sent to the selected call state control function.

7. The method according to claim 1, wherein the stored information comprises a plurality of availability indicators identifying the availability or otherwise of respective call state control functions.

8. The method according to claim 7, wherein each availability indicator has a value which is determined by an unsuccessful registration request to its associated call state control function.

9. The method according to claim 8, wherein unsuccessful registration requests are due to a variety of different error types, each error type being given a weighting, and the value of each availability indicator is changed by an amount determined by the weighting of the error type for an unsuccessful registration request.

10. The method according to claim 8, wherein the value of each availability indicator is cumulative and thus dependent on the number of unsuccessful registration requests to the associated call state control function.

11. The method according to claim 8, wherein a call state control function is indicated as being unavailable if the value of its associated availability indicator is above a threshold value.

12. The method according to claim 11, wherein a black list flag is set for a call state control function when the value of its associated availability indicator is above the threshold value.

13. The method according to claim 8, wherein an upper limit is set for the value of each availability indicator.

14. The method according to claim 8, wherein the value of each availability indicator is periodically reduced.

15. The method according to claim 14, wherein the period and/or size of reduction in the value of each availability indicator is dependent on how long the associated call state control function has been unavailable.

16. The method according to claim 14, wherein a monitoring request is sent to a call state control function when the value of its availability indicator falls below the threshold value to determine whether the call state control function is available.

17. A network element for allocating one of a plurality of call state control functions to a subscriber, the network element being adapted to perform the method of claim 1.

18. A telecommunications network comprising a network element according to claim 17, and a plurality of call state control functions.

19. A computer program product, embodied on a computer readable medium, being adapted to perform the method of claim 1 when the program is run on a computer or on a processor.
